(19) United States
(12) Patent Application Publication
(10) Pub. No.: US 2016/0173986 A1
(43) Pub. Date: Jun. 16, 2016

(54) ULTRA-LOW DISTORTION INTEGRATED LOUDSPEAKER SYSTEM

(71) Applicant: Gary Lloyd Fox, Oro Valley, AZ (US)

(72) Inventor: Gary Lloyd Fox, Oro Valley, AZ (US)

(21) Appl. No.: 14/968,782

(22) Filed: Dec. 14, 2015

Related U.S. Application Data
(60) Provisional application No. 62/092,099, filed on Dec. 15, 2014.

(51) Int. Cl. H04R 3/14; H04R 1/24; H04R 3/04

(52) U.S. Cl. CPC H04R 3/14; H04R 3/04; H04R 1/24

(57) ABSTRACT

An ultra-low distortion loudspeaker is described. The ultra-low distortion, on the order of 0.1% THD (total harmonic distortion) or less, is achieved by novel means. The signal from a typical preamplifier, i.e., line level signal, is fed into an ultra-low distortion, high order band-pass filter, the band-pass filter splitting the component frequencies into various bands. Secondly, the output of each band, or group of bands, is then input to an ultra-low distortion power amplifier, each driving an individual acoustic transducer. The band-pass filters, power amplifiers, and acoustic transducers, along with a suitable enclosure(s), comprise an ultra-low distortion integrated loudspeaker system.

### CROSS-REFERENCE TO RELATED APPLICATIONS

This application claims benefit under 35 U.S.C. §119(e) of U.S. Provisional Application having Ser. No. 62/092099 filed Dec. 15, 2014, which is hereby incorporated by reference herein in its entirety.

### BACKGROUND

The embodiments herein relate generally to loudspeaker systems for ultra-low distortion sound reproduction.

The goal of a high fidelity stereo or home theater system is to provide music and sound that is of the highest clarity and most realistic. The most common measure of acoustic quality is the Total Harmonic Distortion (THD). Another, more accurate measure can be used in conjunction to THD, called Transient Inter-Modulation Distortion (TIM). Current music sources, such as Compact Disks (CDs), Digital Video Disks (DVDs), etc., along with high fidelity preamplifiers and power amplifiers, have THD values on the order of 0.1%.

Conventional speaker systems, on the other hand, produce levels of distortion much higher than many of the sources and components tied to the system. Conventional speaker systems produce distortion on the order of a few percent THD. A primary source of distortion lies in the fact that, typically, only 3 or 4 acoustic transducers are used to produce sound covering many octaves, typically 20 Hz to 20,000 Hz (20 KHz). A secondary source of distortion is also produced by the low order crossover networks used by speakers that are driven by power amplifiers.

Referring now to FIG. 1, a prior art high fidelity stereo system is shown. Home theater systems differ from the speaker system shown in FIG. 1 only in the additional number of loudspeakers used, along with surround sound processing. The conventional speaker system shown uses an active, i.e., powered, sub-woofer with the signal going through a high pass filter back to the pre-amplifier. The filtered signal is passed to a 3-way, (3 acoustic transducers), loudspeaker system that uses internal, low order, passive cross-over circuits. The high power cross-over circuits filter the low, medium, and high frequency signal to the respective acoustic transducers (labeled woofer, mid-range, and tweeter).

Except for the speakers, current high fidelity components have less than 0.1% THD. Due to distortions caused by the cross-over network and the relatively wide frequency range that each acoustic transducer must provide, the speaker system typically produces more than 1% THD in the end result, which as may be appreciated by audiophiles is detectable and diminishes the audio experience.

Embodiments of the present invention provide ultra-low distortion from the output of a speaker system.

### SUMMARY

An ultra-low distortion loudspeaker system for reproducing audio signals in response to line level signals comprises 5 or more acoustic transducers. A plurality of band-pass filters are coupled to the 5 or more acoustic transducers via power amplifiers. An input interface receives the line level signals. The line level signals are decomposed into frequency bands by the plurality of band-pass filters. Each frequency band drives a dedicated power amplifier which, in turn, drive one or more of the 5 or more acoustic transducers.

### BRIEF DESCRIPTION OF THE FIGURES

The detailed description of some embodiments of the invention is made below with reference to the accompanying figures, wherein like numerals represent corresponding parts of the figures.

FIG. 1 is a block diagram of a conventional speaker system.

FIG. 2 is a block diagram of an ultra-low distortion system according to embodiments of the subject technology.

FIG. 3 is a schematic of frequency band distribution among power amplifiers driving acoustic transducers for the system of FIG. 2.

FIG. 4 is a schematic of a multi-band-pass filter for octave band filtering according to another exemplary embodiment.

### DETAILED DESCRIPTION OF CERTAIN EMBODIMENTS

Broadly, embodiments of the disclosed invention provide an ultra-low distortion speaker system. A line level signal is fed into an ultra-low distortion, high order band-pass filter splitting the component frequencies into various bands. The output of each band-pass filter is then input to one or more ultra-low distortion power amplifiers. Each power amplifier drives one or more individual acoustic transducer to produce ultra-low distortion sound.

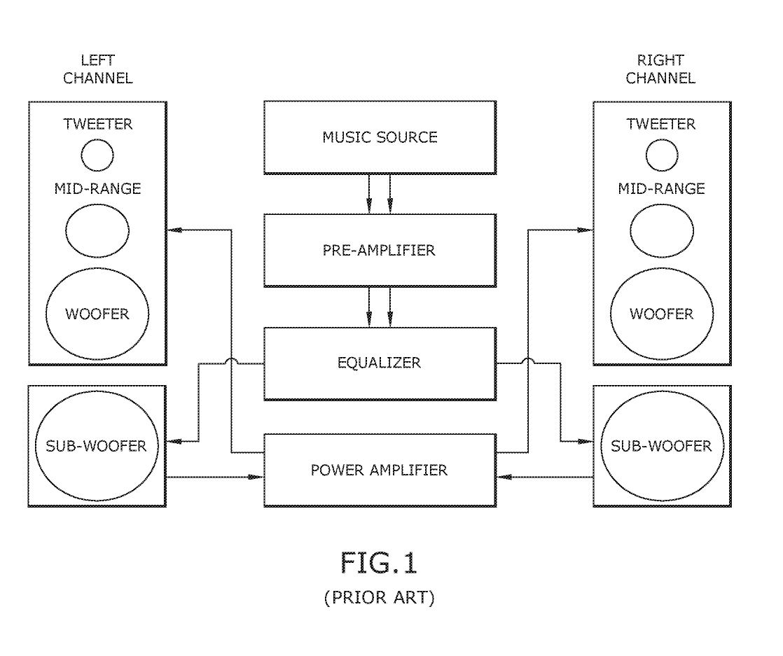

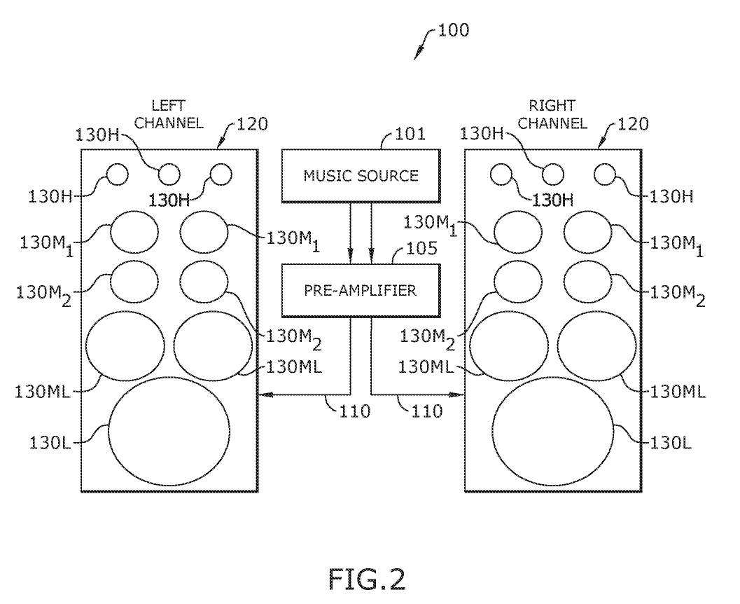

Referring now to FIG. 2, a system 100 includes an audio source 101 (for example, a source playing music) which provides a signal to a pre-amplifier 105 which then feeds a line level signal 110 to channel outputs 120 (shown in the form of speaker boxes). The line level signal 110 may be analog or digital and may be converted as necessary as is known in the art. In an exemplary embodiment, the system 100 includes both left and right channel outputs 120 of the pre-amplifier 105. It should be appreciated that the power amplifier, sub-woofer feedback circuit, and equalizer which may be present in a conventional speaker system (FIG. 1) are eliminated producing a much simpler in-home wiring arrangement. In the exemplary embodiment shown, each channel of high order band-pass filters has ten outputs (generally designated as 130): 3 transducers 130_{H} for the high bands, 4 transducers 130_{M1} and 130_{M2} for the mid bands; 2 transducers 130_{ML} for the mid-low bands; and 1 transducer 130_{L} for the low band.

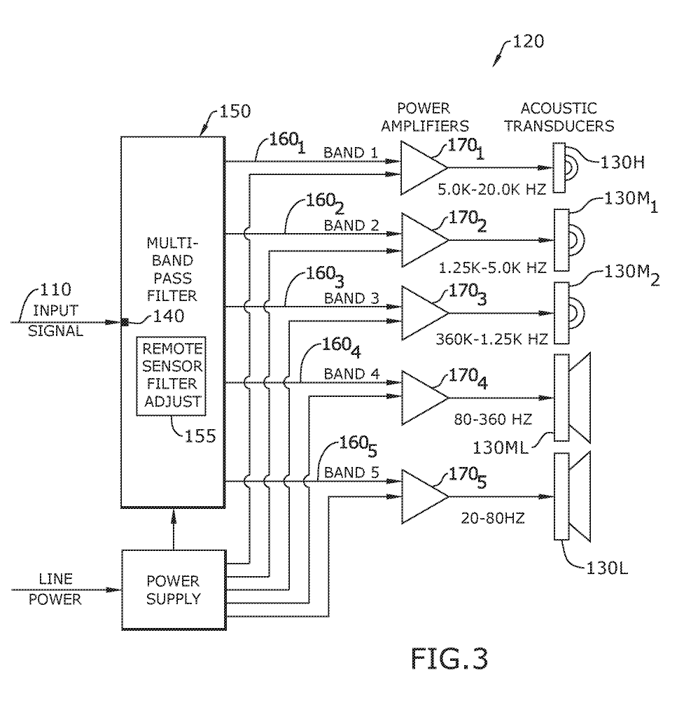

Referring now to FIG. 3, distribution of the line level input signal 110 is shown in accordance with an exemplary embodiment. It will be understood that the elements described in FIG. 3 are internal to each channel (for example within each speaker box). Each transducer 130 is independently powered by a power amplifier 170 (shown as power amplifiers 170₁-170₅). A multi-bandpass filter 150 splits the input acoustic signal 110 (received through an input interface 140) into n or more frequency bands 160; n being 5 or more (shown as bands 160₁-160₅). Each frequency band 160 from the band-pass filter 150 drives one or more dedicated power amplifiers 170. Each frequency band 160 may be discrete from the other frequency bands 160 so that no two frequency bands 160 overlap. For sake of illustration, five acoustic transducers 130 are shown, each transducer independently covering approximately two octave bands within the range of 20 Hz to 20 kHz. However, it will be understood that more than 5 transducers 130 may be employed (for example as shown in FIG. 2) to distribute the frequency bands 160 among more independently moving transducers 130. Each transducer 130 is thus responsible for moving within its range of frequency and velocity. As a result, Doppler distortion may be eliminated since each transducer 130 is not required to move at different speeds within the conventional distribution of frequencies present in prior art systems. In addition distortion associated with high power, low roll-off cross-over networks is eliminated since the output frequencies for each transducer 130 is narrowed. In some embodiments, a remote sensor 155 may be on an equalizer and may allow the user to control the gain of the various band-pass filters remotely. The remote control may be, for example, a hand held personal communication device, such as a Bluetooth application on a smart phone or tablet PC (not shown).

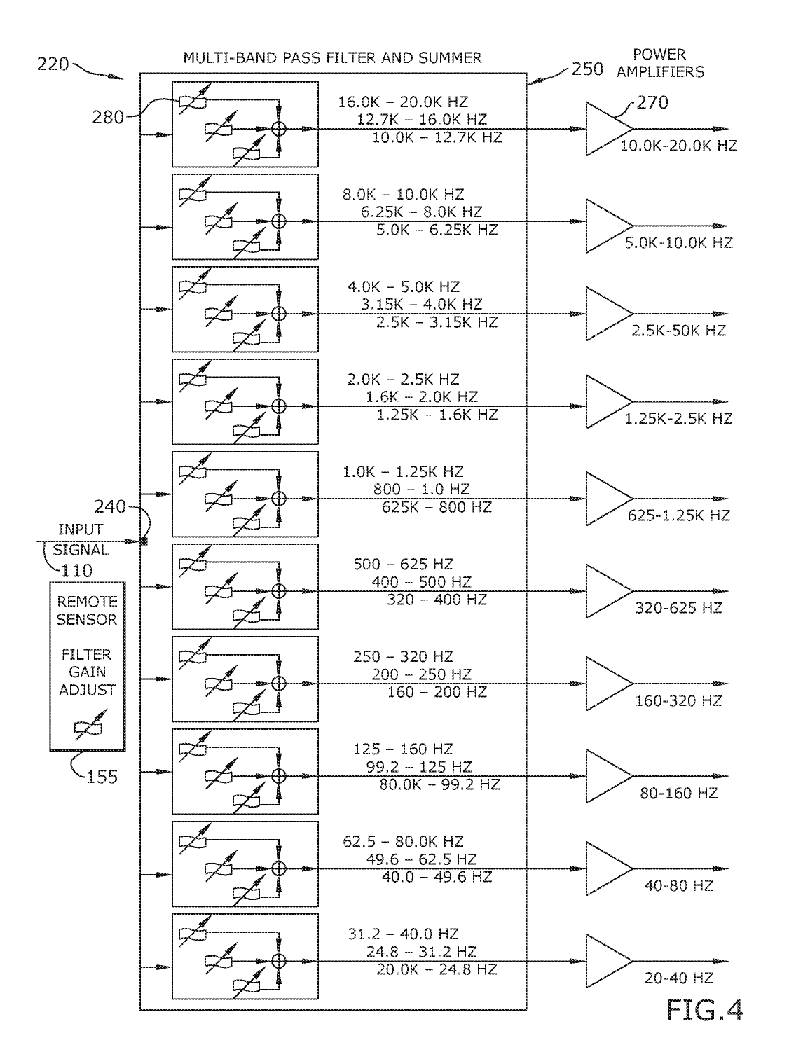

Referring now to FIG. 4, another exemplary embodiment of an output channel 220 is shown. Exemplary embodiments may include any number of transducers that are independently powered by any number of summed frequency bands. The frequency bands input to individual summers may be of arbitrary narrow bands within the range of approximately 20 Hz to 20 kHz. For example, the embodiment shown in FIG. 4 is similar to the embodiment in FIG. 3 except that a multi-band pass filter and summer 250 outputting octave band input into power amplifiers 270 is used to drive a plurality (n greater than 5) of acoustic transducers (not shown). In some embodiments, the multi-band pass filter and summer 250 may include octave band or ⅓ octave band filters 280. The input interface 240 may provide the line level signal 110 into the multi-band pass filter and summer 250 which filters the line level signal 110 into ⅓ octave band frequencies. A set of three band filters 280 may split the line level signal 110 into three separate frequency outputs for each ⅓ octave band. The narrower filter outputs may be summed into octave bands before being passed on to the power amplifiers 270. For example, 30 separate filters, summed into ten octave bands, may be arranged to provide for ⅓ octave band equalization. As may be appreciated, each power amplifier 270 is driven within its own narrow frequency range to produce low distortion output yet still provides the popular ⅓ octave band equalization for each transducer output. It will also be understood that other arrangements are possible, for example using ⅓ octave band-pass filters 280, but fed directly into ⅓ octave band outputs to the power amplifiers 280 and acoustic transducers. Still yet, a system channel 220 may include for example 1/20 octave band filters and summers to reduce the output to 1/10 octave band (summing 2 bands for each summer) and have acoustic transducers operating in the 16 Hz to 32 K Hz range, resulting in more than 100 acoustic transducers operating independently to produce output in the narrower ranges thus providing less distortion.

Persons of ordinary skill in the art may appreciate that numerous design configurations may be possible to enjoy the functional benefits of the inventive systems. Thus, given the wide variety of configurations and arrangements of embodiments of the present invention the scope of the invention is reflected by the breadth of the claims below rather than narrowed by the embodiments described above. Also, the addition of powered sub-woofers to augment an embodiment will not invalidate the claims of this invention.

A phrase such as an “aspect” does not imply that such aspect is essential to the subject technology or that such aspect applies to all configurations of the subject technology. A disclosure relating to an aspect may apply to all configurations, or one or more configurations. An aspect may provide one or more examples. A phrase such as an aspect may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples. A phrase such an embodiment may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples. A phrase such a configuration may refer to one or more configurations and vice versa.

The word “exemplary” is used herein to mean “serving as an example or illustration.” Any aspect or design described herein as “exemplary” is not necessarily to be construed as preferred or advantageous over other aspects or designs.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.” Furthermore, to the extent that the term “include,” “have,” or the like is used in the description or the claims, such term is intended to be inclusive in a manner similar to the term “comprise” as “comprise” is interpreted when employed as a transitional word in a claim.

What is claimed is:

1. An ultra-low distortion loudspeaker system for reproducing audio signals in response to line level signals, comprising:
5 or more acoustic transducers;
a plurality of band-pass filters coupled to the 5 or more acoustic transducers via power amplifiers; and
an input interface for receiving the line level signals, wherein line level signals are decomposed into frequency bands by the plurality of band-pass filters, each frequency band driving a dedicated power amplifier among a plurality of power amplifiers, each dedicated power amplifier, in turn, driving one or more of the 5 or more acoustic transducers.

2. The ultra-low distortion loudspeaker system of claim 1, wherein no two frequency bands overlap in frequency.

3. The ultra-low distortion loudspeaker system of claim 1, wherein the band-pass filters are octave band filters.

4. The ultra-low distortion loudspeaker system of claim 1, wherein the band-pass filters are ⅓ octave band filters.

5. The ultra-low distortion loudspeaker system of claim 4, further comprising a summer coupled to the plurality of ⅓ octave band filters, the summer and the plurality of ⅓ octave band filters producing ⅓ octave band outputs to the plurality of power amplifiers.

6. The ultra-low distortion loudspeaker system of claim 1, wherein each transducer independently outputs approximately two octave bands within the range of approximately 20 Hz to 20 kHz.

7. The ultra-low distortion loudspeaker system of claim 1, wherein any number of transducers are independently powered by any number of summed frequency bands, wherein the frequency bands input to the individual summers may be of arbitrary narrow bands within the range of approximately 20 Hz to 20 kHz.
